(19) United States
(12) Patent Application Publication
(10) Pub. No.: US 2023/0250361 A1
(43) Pub. Date: Aug. 10, 2023

(54) METHOD OF LAUNDERING FABRIC

(71) Applicant: The Procter & Gamble Company, Cincinnati, OH (US)

(72) Inventors: Alan Thomas BROOKER, NEWCASTLE UPON TYNE (GB); Anna CELMINA, EDINBURGH (GB); Sarah Jane DOUGLASS, NEWCASTLE UPON TYNE (GB); Linsey Sarah FULLER, NEWCASTLE UPON TYNE (GB); Eric San Jose ROBLES, NEWCASTLE UPON TYNE (GB); Robert William John STERRY, NEWCASTLE UPON TYNE (GB); Aaron Ryan Wawell Tiu SY, BEIJING (CN)

(21) Appl. No.: 18/107,090

(22) Filed: Feb. 8, 2023

(30) Foreign Application Priority Data
Feb. 8, 2022 (WO) PCT/CN2022/075444

(51) Int. Cl. C11D 1/37; C11D 11/00; C11D 3/00; C11D 3/50; C11D 3/42; C11D 3/20; C11D 3/386

(52) U.S. Cl. CPC C11D 1/37; C11D 11/0017; C11D 3/0084; C11D 3/50; C11D 3/42; C11D 3/2093; C11D 3/386; C11D 1/26

(57) ABSTRACT

A method of laundering fabric including the steps of: (a) contacting a detergent composition including linear alkylbenzene sulphonate detersive surfactant, C₈-C₂₄ alkyl sulphate detersive surfactant and phenolic antioxidant with water to form a wash liquor including from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200; (b) contacting fabric with the wash liquor; and (c) laundering the fabric.

### FIELD OF THE INVENTION

The present invention relates to a method of laundering fabric. The method comprises the steps of: (a) contacting a detergent composition comprising linear alkylbenzene sulphonate detersive surfactant, C₈-C₂₄ alkyl sulphate detersive surfactant and phenolic antioxidant with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200; (b) contacting fabric with the wash liquor; and (c) laundering the fabric.

The method of the present invention provides good cleaning and enhanced suds generation from the wash solution

### BACKGROUND OF THE INVENTION

During the laundering of fabric, the generation of suds is an important indicator to the launderer that the laundry detergent is working and the fabrics are being cleaned. Establishing a suds profile quickly and maintaining an adequate suds profile during the laundering process is important. Iron is (unintentionally) introduced into the wash solution by a variety of sources, such as the water supply, soil from the fabrics, and impurities in the laundry detergent product, etc. Iron can negatively affect the suds profile during laundering. The inventors have surprisingly found that the presence of phenolic antioxidant overcomes the negative sudsing effect caused by iron during the laundering process for a specific detersive surfactant system comprising linear alkylbenzene sulphonate detersive surfactant and C₈-C₂₄ alkyl sulphate detersive surfactant.

### SUMMARY OF THE INVENTION

The present invention provides a method of laundering fabric comprising the steps of:
(a) contacting a detergent composition comprising linear alkylbenzene sulphonate detersive surfactant, C₈-C₂₄ alkyl sulphate detersive surfactant and phenolic antioxidant having the structure:

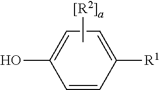

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₁₈ linear or branched alkyl; —O—Q—O—G, where Q is selected from the group consisting of:
C₂-C₈ linear or branched alkylene, optionally containing therein one or more ether, thioether or oxamide groups;

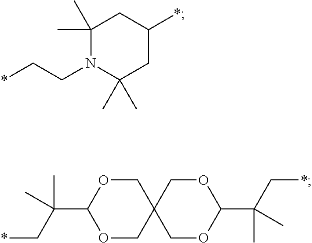

and any combination thereof;

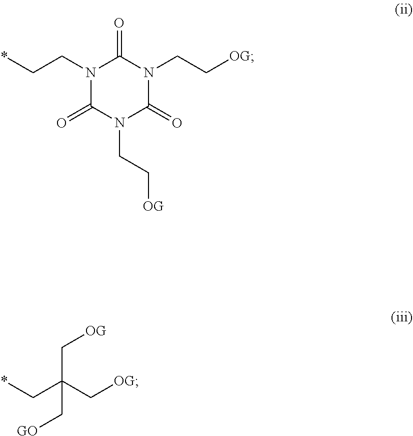

and
(iv) any combination thereof;
wherein each G is independently selected from the group consisting of H and

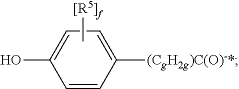

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group,
with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200;
(b) contacting fabric with the wash liquor; and
(c) laundering the fabric.

### DETAILED DESCRIPTION OF THE INVENTION

### Method of Laundering Fabric

The method comprises the steps of: (a) contacting a detergent composition comprising linear alkylbenzene sulphonate detersive surfactant, C₈-C₂₄ alkyl sulphate detersive surfactant and phenolic antioxidant with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200; (b) contacting fabric with the wash liquor; and (c) laundering the fabric.

The method typically involves a drying step, usually after step (c). Suitable drying steps include line drying and machine drying (tumble-drying).

### Step (a)

Step (a) contacts a detergent composition with water to form a wash liquor

### Step (b)

Step (b) contacts fabric with the wash liquor.

### Step (c)

Step (c) launders the fabric.

### Wash Liquor

The wash liquor formed during step (a) comprises from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron.

The wash liquor has a pH in the range of from greater than 7.0 to 12.0. The wash liquor may have a pH of from 10.0 to 12.0. Alternatively, the wash liquor may have a pH of from above 7.0 to less than 10.0.

The molar ratio of linear alkylbenzene sulphonate detersive surfactant to C₈-C₂₄ alkyl sulphate detersive surfactant present in the wash liquor is in the range of from 0.05 to 200, preferably 0.1 to 50.

The C₈-C₂₄ alkyl sulphate detersive surfactant is preferably a C₁₂-C₁₄ alkyl sulphate detersive surfactant.

The linear alkylbenzene sulphonate detersive surfactant is preferably a C₁₁-C₁₃ linear alkylbenzene sulphonate.

The wash liquor may comprise from 0.4 ppm to 5.0 ppm iron.

The wash liquor may comprise from 0.4 ppm to 200 ppm chelant. The chelant is preferably selected from DETA, MGDA, EDDS, TETA, and any combination thereof.

The wash liquor may comprise from 0.2 ppm to 200 ppm perfume.

The wash liquor may comprise from 0.2 ppm to 80 ppm protease.

The wash liquor may comprise from 0.01 ppm to 200 ppm hueing agent.

### Phenolic Antioxidant

The phenolic antioxidant has the structure:

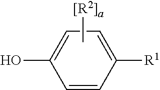

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₈ linear or branched alkyl; —O—Q—O—G, where Q is selected from the group consisting of:
C₂-C₈ linear or branched alkylene, optionally containing therein one or more ether, thioether or oxamide groups;

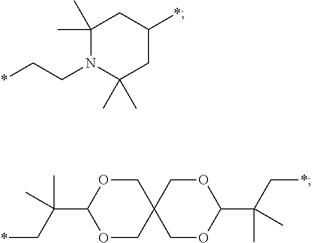

and any combination thereof;

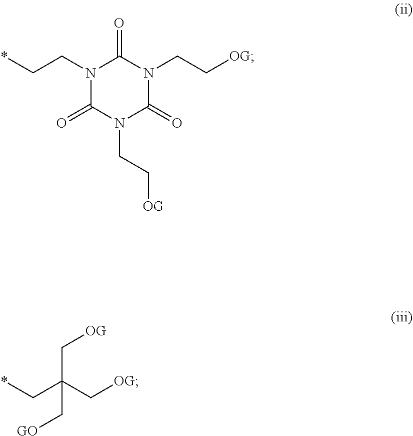

and
(iv) any combination thereof;
wherein each G is independently selected from the group consisting of H and

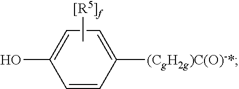

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group,
with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200;
(b) contacting fabric with the wash liquor; and
(c) laundering the fabric.

Preferably, the phenolic antioxidant has a structure selected from:

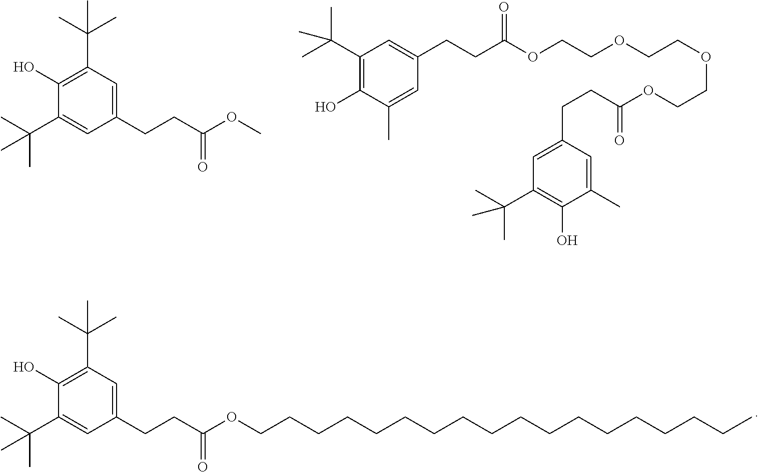 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

Most preferably, the phenolic antioxidant is octadecyl di-t-butyl-4-hydroxyhydrocinnamate.

A suitable phenolic antioxidant is Tinogard TS®.

Typically, commercial sources of suitable phenolic antioxidants comprise low levels of impurities such as esters, alcohols, carboxylic acids and the like. Such impurities are usually present due to by-products of synthesis reactions or form during storage of the phenolic antioxidant. Such impurities do not affect the performance of the phenolic antioxidant.

### Detergent Composition

The detergent composition comprises linear alkylbenzene sulphonate detersive surfactant, C₈-C₂₄ alkyl sulphate detersive surfactant and phenolic antioxidant.

The detergent composition may comprise chelant. Preferably, the chelant is selected from DETA, MGDA, EDDS, TETA, and any combination thereof.

Suitable chelating agents may be present at a level of from about 0.1% to about 10%, or to about 5%, or to about 2%, by weight of the composition. The chelating agent(s) may be present in the composition at a level of from about 0.1% to about 10%, preferably to about 5%, by weight of the composition.

Suitable chelating agents may include phosphonates, aminocarboxylates, amino phosphonates, polyfunctionally-substituted aromatic chelating agents, or mixtures thereof, preferably aminocarboxylates. The chelating agents, as used herein, are not intended to include traditional builders, such as citric acid, although such builders may be present in compositions of the present disclosure.

Aminocarboxylates useful as chelating agents include, but are not limited to, ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, and ethanoldiglycines, alkali metal, ammonium, and substituted ammonium salts thereof, and mixtures thereof. Aminophosphonates are also suitable for use as chelating agents in the compositions of the invention when low levels of total phosphorus are permitted, and include ethylenediaminetetrakis (methylenephosphonates). Polyfunctionally-substituted aromatic chelating agents may include catechols, for example sulphonated catechols.

Suitable chelating agents may include: DTPA (diethylenetriaminepentaacetic acid), HEDP (hydroxyethanediphosphonic acid), EDDS (ethylenediamine disuccinate (EDDS), DTPMP (diethylene triamine penta (methylene phosphonic acid)), EDTMP (ethylene diamine tetra(methylene phosphonic acid)), Tiron® (1,2-diydroxybenzene-3,5-disulfonic acid), HPNO (2-pyridinol-N-oxide), MGDA (methylglycinediacetic acid), GLDA (glutamic-N,N-diacetic acid), any suitable derivative thereof, salts thereof, and mixtures thereof.

The detergent composition may comprise perfume.

The detergent composition may comprise protease.

The detergent composition may comprise hueing agent.

### Laundry Detergent Composition

Suitable laundry detergent compositions include laundry detergent powder compositions, laundry detergent liquid compositions, laundry detergent gel compositions, and water-soluble laundry detergent compositions.

Typically, the solid free-flowing particulate laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0 gNaOH/100 g. These low buffered laundry detergent compositions typically comprise low levels of carbonate salt.

Detersive Surfactant: Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic detersive surfactant: Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Non-ionic detersive surfactant: Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Cationic detersive surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Zwitterionic detersive surfactant: Suitable zwitterionic detersive surfactants include amine oxides and/or betaines.

Polymer: Suitable polymers include carboxylate polymers, soil release polymers, anti-redeposition polymers, cellulosic polymers, care polymers and any combination thereof.

Carboxylate polymer: The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

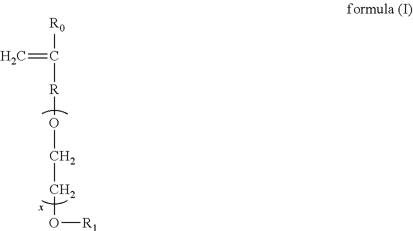

wherein in formula (I), Ro represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

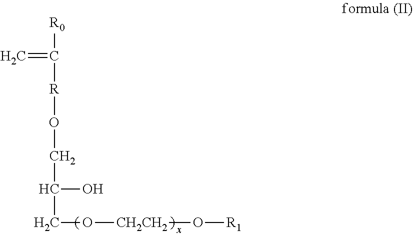

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Soil Release Polymer: The composition may comprise a soil release polymer. A suitable soil release polymer has a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC—sAr—CO—]ₑ (II)

—[(OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Anti-redeposition Polymer: Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

Cellulosic Polymer: Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care Polymers: Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach: Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of Hydrogen Peroxide: Suitable sources of hydrogen peroxide include sodium perborate and/or sodium percarbonate.

Bleach Activator: Suitable bleach activators include tetra acetyl ethylene diamine and/or alkyl oxybenzene sulphonate.

Bleach Catalyst: The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

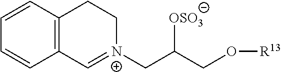

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-formed Peracid: Suitable pre-form peracids include phthalimido-peroxycaproic acid.

Enzymes: Suitable enzymes include lipases, proteases, cellulases, amylases and any combination thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the folowing mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

A suitable protease is described in WO11/140316 and WO11/072117.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO06/002643.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other Suitable Lipases Include: Liprl 139, e.g. as described in WO2013/171241; and TfuLip2, e.g. as described in WO2011/084412 and WO2013/033318.

Other Enzymes: Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other Suitable Enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Zeolite Builder: The composition may comprise zeolite builder. The composition may comprise from 0 wt % to 5wt % zeolite builder, or 3wt % zeolite builder. The composition may even be substantially free of zeolite builder; substantially free means “no deliberately added”. Typical zeolite builders include zeolite A, zeolite P and zeolite MAP.

Phosphate Builder: The composition may comprise phosphate builder. The composition may comprise from 0 wt % to 5wt % phosphate builder, or to 3wt %, phosphate builder. The composition may even be substantially free of phosphate builder; substantially free means “no deliberately added”. A typical phosphate builder is sodium tri-polyphosphate.

Carbonate Salt: The composition may comprise carbonate salt. The composition may comprise from 0wt % to 10 wt % carbonate salt, or to 5wt % carbonate salt. The composition may even be substantially free of carbonate salt; substantially free means “no deliberately added”. Suitable carbonate salts include sodium carbonate and sodium bicarbonate.

Silicate salt: The composition may comprise silicate salt. The composition may comprise from 0wt % to 10 wt % silicate salt, or to 5wt % silicate salt. A preferred silicate salt is sodium silicate, especially preferred are sodium silicates having a Na₂O:SiO₂ ratio of from 1.0 to 2.8, preferably from 1.6 to 2.0.

Sulphate salt: A suitable sulphate salt is sodium sulphate.

Brightener: Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5- triazin-2-yl)];amino}stilbene-2-2′ disulfonate, disodium 4,4′-bis{[(4-anilino-6-morpholino- 1,3,5-triazin-2-yl)]amino} stilbene-2-2′ disulfonate, and disodium 4,4′- bis(2-sulfostyryl)biphenyl. A suitable fluorescent brightener is C.I. Fluorescent Brightener 260, which may be used in its beta or alpha crystalline forms, or a mixture of these forms.

Chelant: The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′- disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing agent: Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

Dye Transfer Inhibitors: Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Perfume: Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

Silicone: Suitable silicones include polydimethylsiloxane and amino-silicones. Suitable silicones are described in WO05075616.

Process for Making the Solid Composition: Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Method of Laundering Fabric: The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Embodiments of the Present Invention

The following are embodiments of the present invention.

1. A method of laundering fabric comprising the steps of:
(a) contacting a detergent composition comprising linear alkylbenzene sulphonate detersive surfactant, C₈-C₂₄ alkyl sulphate detersive surfactant and phenolic antioxidant having the structure:

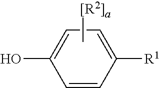

wherein the index a is 1 or 2,
wherein when a is 1, R² is t-butyl and R¹ is -OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₁₈ linear or branched alkyl; —O—Q—O—G, where Q is selected from the group consisting of:
C₂-C₈ linear or branched alkylene, optionally containing therein one or more ether, thioether or oxamide groups;

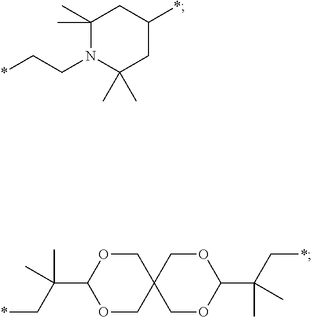

and any combination thereof;

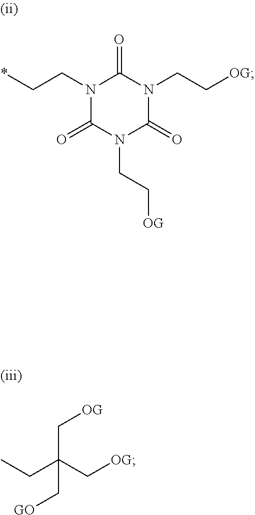

and
(iv) any combination thereof;
wherein each G is independently selected from the group consisting of H and

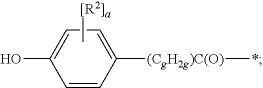

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group,
with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200;
(b) contacting fabric with the wash liquor; and
(c) laundering the fabric.
   2. A method according to embodiment 1, wherein the phenolic antioxidant has a structure selected from:

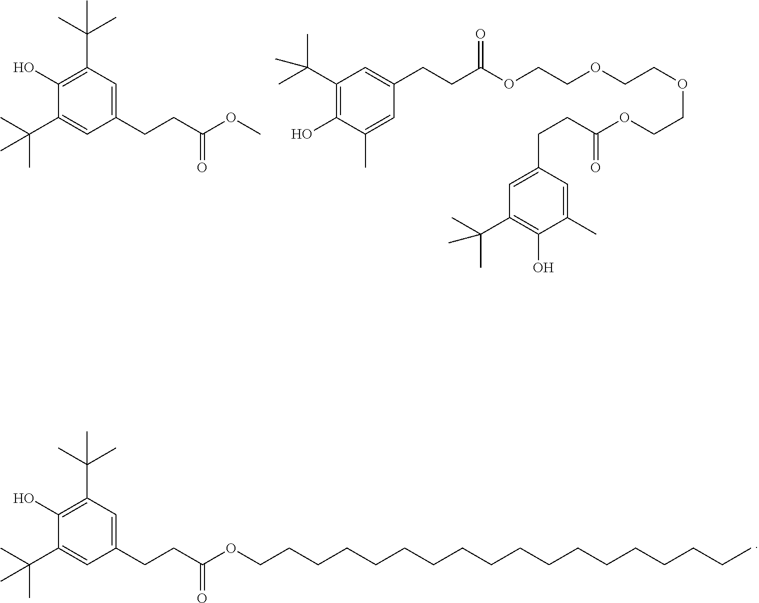 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

3. A method according to any preceding embodiment, wherein the phenolic antioxidant is octadecyl di-t-butyl-4-hydroxyhydrocinnamate.
4. A method according to any preceding embodiment, wherein the C₈-C₂₄ alkyl sulphate detersive surfactant is a C₁₂-C₁₄ alkyl sulphate detersive surfactant.
5. A method according to any preceding embodiment, wherein the linear alkylbenzene sulphonate detersive surfactant is a C₁₁-C₁₃ linear alkylbenzene sulphonate.
6. A method according to any preceding embodiment, wherein the molar ratio of linear alkylbenzene sulphonate detersive surfactant and C₈-C₂₄ alkyl sulphate detersive surfactant present in the wash liquor is in the range of from 0.1 to 50.
7. A method according to any preceding embodiment, wherein the wash liquor comprises from 0.4 ppm to 5.0 ppm iron.
8. A method according to any preceding embodiment, wherein the wash liquor has a pH of from 10.0 to 12.0.
9. A method according to any of embodiment 1-7, wherein the wash liquor has a pH of from above 7.0 to less than 10.0.
10. A method according to any preceding embodiment, wherein the detergent composition comprises chelant, and wherein the wash liquor comprises from 0.4 ppm to 200 ppm chelant.
11. A method according to embodiment 10, wherein the chelant is selected from DETA, MGDA, EDDS, TETA, and any combination thereof.
12. A method according to any preceding embodiment, wherein the detergent composition comprises perfume, and wherein the wash liquor comprises from 0.2 ppm to 200 ppm perfume.
13. A method according to any preceding embodiment, wherein the detergent composition comprises protease, and wherein the wash liquor comprises from 0.2 ppm to 80 ppm protease.
14. A method according to any preceding embodiment, wherein the detergent composition comprises hueing agent, and wherein the wash liquor comprises from 0.01 ppm to 200 ppm hueing agent.
15. Use of phenolic antioxidant having the structure

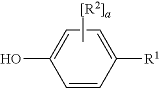

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₁₈ linear or branched alkyl; —O—Q—O—G, where Q is selected from the group consisting of:
C₂-C₈ linear or branched alkylene, optionally containing therein one or more ether, thioether or oxamide groups;

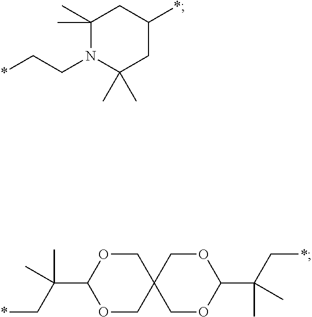

and any combination thereof;

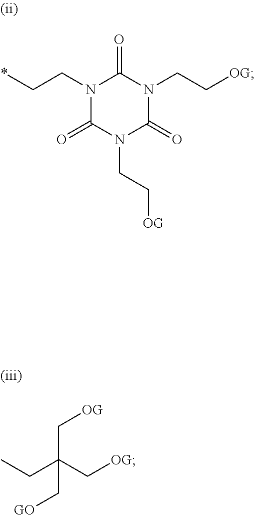

and
(iv) any combination thereof;
wherein each G is independently selected from the group consisting of H and

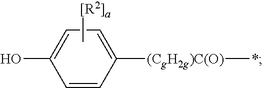

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group,
to enhance the generation of suds from a wash solution comprising from 0.001 ppm to 10.0 ppm iron and from 60 ppm to 2750 ppm detersive surfactant during a laundering process.

### EXAMPLES

### Examples

Thirteen powder detergent compositions (Compositions 1-13) were made and tested as detailed herein below.

### Test Method

### I. Preparation of Test Compositions

Tests were carried out using the following detergent compositions Material additions shown at active material level in finished product (FP).

| | Level (g/100 g FP) | | | | | | | |
|---|---|---|---|---|---|---|---|---|
| | Composition | | | | | | | |
| Ingredient | 1 | 2 | 3 | 4 | 5 | 6 | 7 | ppm* |
| disodium 4,4′-bis[(4- | 0.113 | 0.113 | 0.113 | 0.113 | 0.113 | 0.113 | 0.113 | 4.52 |
| anilino-6-morpholino- | | | | | | | | |
| 1,3,5-triazin-2- | | | | | | | | |
| yl)amino]stilbene-2,2′- | | | | | | | | |
| disulphonate | | | | | | | | |
| Disodium 4,4′-Bis-(2- | 0.038 | 0.038 | 0.038 | 0.038 | 0.038 | 0.038 | 0.038 | 1.52 |
| Sulfostyryl) Biphenyl | | | | | | | | |
| Carboxymethyl | 0.114 | 0.114 | 0.114 | 0.114 | 0.114 | 0.114 | 0.114 | 4.56 |
| Cellulose | | | | | | | | |
| Lipase | 0.0014 | 0.0014 | 0.0014 | 0.0014 | 0.0014 | 0.0014 | 0.0014 | 0.056 |
| DTPA Agglomerate | 0.281 | 0.281 | 0.281 | 0.281 | 0.281 | 0.281 | 0.281 | 11.24 |
| Sokalan CP 5 (polymer | 0.777 | 0.777 | 0.777 | 0.777 | 0.777 | 0.777 | 0.777 | 31.08 |
| supplied by BASF) | | | | | | | | |
| Phosphodiesterase | 0.002 | 0.002 | 0.002 | 0.002 | 0.002 | 0.002 | 0.002 | 0.08 |
| LAS | 14.785 | 14.785 | 14.785 | 14.785 | 14.785 | 14.785 | 14.785 | 591.4 |
| Hueing Dye | 0.038 | 0.038 | 0.038 | 0.038 | 0.038 | 0.038 | 0.038 | 1.52 |
| Mannanase | 0.0001 | 0.0001 | 0.0001 | 0.0001 | 0.0001 | 0.0001 | 0.0001 | 0.004 |
| Sodium Carbonate | 21.140 | 21.140 | 21.140 | 21.140 | 21.140 | 21.140 | 21.140 | 845.6 |
| Sodium Sulphate | 46.632 | 46.532 | 46.450 | 46.414 | 46.498 | 46.394 | 46.229 | 1849.16 |
| Amylase | 0.0006 | 0.0006 | 0.0006 | 0.0006 | 0.0006 | 0.0006 | 0.0006 | 0.024 |
| Sodium Percarbonate | 3.000 | 3.000 | 3.000 | 3.000 | 3.000 | 3.000 | 3.000 | 120.00 |
| Protease | 0.008 | 0.008 | 0.008 | 0.008 | 0.008 | 0.008 | 0.008 | 0.32 |
| C12-14-alkyl sulfate | 4.538 | 4.538 | 4.538 | 4.538 | 4.538 | 4.538 | 4.538 | 181.52 |
| sodium salt | | | | | | | | |
| Silicate - 2.35R | 1.339 | 1.339 | 1.339 | 1.339 | 1.339 | 1.339 | 1.339 | 53.56 |
| Tetraacetylethylenediamine | 0.4 | 0.4 | 0.4 | 0.4 | 0.4 | 0.4 | 0.4 | 16.00 |
| Zeolite A | 2.678 | 2.678 | 2.678 | 2.678 | 2.678 | 2.678 | 2.678 | 107.12 |
| Methyl 3-(3,5-di-tert- | 0.000 | 0.100 | 0.000 | 0.000 | 0.000 | 0.000 | 0.000 | 4.00 |
| butyl-4-hydroxyphenyl) | | | | | | | | |
| propanoate | | | | | | | | |
| Octadecyl 3-(3,5-di- | 0.000 | 0.000 | 0.182 | 0.000 | 0.000 | 0.000 | 0.000 | 7.28 |
| tert-butyl-4-hydroxy- | | | | | | | | |
| phenyl) propionate | | | | | | | | |
| Irganox 259 | 0.000 | 0.000 | 0.000 | 0.218 | 0.000 | 0.000 | 0.000 | 8.72 |
| Irganox 1150 | 0.000 | 0.000 | 0.000 | 0.000 | 0.134 | 0.000 | 0.000 | 5.36 |
| MD697 | 0.000 | 0.000 | 0.000 | 0.000 | 0.000 | 0.238 | 0.000 | 9.52 |
| Tinogard TT | 0.000 | 0.000 | 0.000 | 0.000 | 0.000 | 0.000 | 0.403 | 16.12 |
| Water | 1.767 | 1.767 | 1.767 | 1.767 | 1.767 | 1.767 | 1.767 | 70.68 |
| Perfume, processing | 2.348 | 2.348 | 2.348 | 2.348 | 2.348 | 2.348 | 2.348 | 93.92 |
| aids and aesthetics | | | | | | | | |
| Total Parts | 100.000 | 100.000 | 100.000 | 100.000 | 100.000 | 100.000 | 100.000 | 4000 |

| | Level (g/100 g FP) | | | |
|---|---|---|---|---|
| | Composition | | | |
| Ingredient | 8 | 9 | 10 | ppm* |
| disodium 4,4′-bis[(4-anilino-6-morpholino-1,3,5-triazin-2- | 0.113 | 0.113 | 0.113 | 4.52 |
| yl)amino ]stilbene-2,2′-disulphonate | | | | |
| Disodium 4,4′-Bis-(2-Sulfostyryl) Biphenyl | 0.038 | 0.038 | 0.038 | 1.52 |
| Carboxymethyl Cellulose | 0.114 | 0.114 | 0.114 | 4.56 |
| Lipase | 0.0014 | 0.0014 | 0.0014 | 0.056 |
| DTPA Agglomerate | 0.281 | 0.281 | 0.281 | 11.24 |
| Sokalan CP 5 (polymer supplied by BASF) | 0.777 | 0.777 | 0.777 | 31.08 |
| Phosphodiesterase | 0.002 | 0.002 | 0.002 | 0.08 |
| LAS | 14.785 | 14.785 | 14.785 | 591.4 |
| Hueing Dye | 0.038 | 0.038 | 0.038 | 1.52 |
| Mannanase | 0.0001 | 0.0001 | 0.0001 | 0.004 |
| Sodium Carbonate | 21.140 | 21.140 | 21.140 | 845.6 |
| Sodium Sulphate | 46.532 | 46.532 | 46.532 | 1861.28 |
| Amylase | 0.0006 | 0.0006 | 0.0006 | 0.024 |
| Sodium Percarbonate | 3.000 | 3.000 | 3.000 | 120.00 |
| Protease | 0.008 | 0.008 | 0.008 | 0.32 |
| C12-14-alkyl sulfate sodium salt | 4.538 | 4.538 | 4.538 | 181.52 |
| Silicate - 2.35R | 1.339 | 1.339 | 1.339 | 53.56 |
| Tetraacetylethylenediamine | 0.400 | 0.400 | 0.400 | 16.00 |
| Zeolite A | 2.678 | 2.678 | 2.678 | 107.12 |
| Octadecyl 3-(3,5-di-tert-butyl-4-hydroxy-phenyl) | 0.100 | 0.000 | 0.000 | 4.00 |
| propionate | | | | |
| Irganox 259 | 0.000 | 0.100 | 0.000 | 4.00 |
| MD697 | 0.000 | 0.000 | 0.100 | 4.00 |
| Water | 1.767 | 1.767 | 1.767 | 70.68 |
| Perfume, processing aids and aesthetics | 2.348 | 2.348 | 2.348 | 93.92 |
| Total Parts | 100.000 | 100.000 | 100.000 | 4000 |

| | Level (g/100 g FP) | | |
|---|---|---|---|
| | Composition | | |
| Ingredient | 11 | 12 | ppm* |
| disodium 4,4′-bis[(4-anilino-6-morpholino-1,3,5-triazin-2- | 0.113 | 0.113 | 4.52 |
| yl)amino ]stilbene-2,2′-disulphonate | | | |
| Disodium 4,4′-Bis-(2-Sulfostyryl)Biphenyl | 0.038 | 0.038 | 1.52 |
| Carboxymethyl Cellulose | 0.114 | 0.114 | 4.56 |
| Lipase | 0.0014 | 0.0014 | 0.056 |
| DTPA Agglomerate | 0.281 | 0.281 | 11.24 |
| Sokalan CP 5 (polymer supplied by BASF) | 0.777 | 0.777 | 31.08 |
| Phosphodiesterase | 0.002 | 0.002 | 0.08 |
| LAS | 14.785 | 14.785 | 591.4 |
| Hueing Dye | 0.038 | 0.038 | 1.52 |
| Mannanase | 0.0001 | 0.0001 | 0.004 |
| Sodium Carbonate | 21.140 | 21.140 | 845.6 |
| Sodium Sulphate | 46.557 | 46.570 | 1862.8 |
| Amylase | 0.0006 | 0.0006 | 0.024 |
| Sodium Percarbonate | 3.000 | 3.000 | 120 |
| Protease | 0.008 | 0.008 | 0.32 |
| C12-14-alkyl sulfate sodium salt | 4.538 | 4.538 | 181.52 |
| Silicate - 2.35R | 1.339 | 1.339 | 53.56 |
| Tetraacetylethylenediamine | 0.400 | 0.400 | 16 |
| Zeolite A | 2.678 | 2.678 | 107.12 |
| Butylated Hydroxytoluene | 0.075 | 0.000 | 3 |
| Butylated Hydroxyanisole | 0.000 | 0.062 | 2.48 |
| Water | 1.767 | 1.767 | 70.68 |
| Perfume, processing aids and aesthetics | 2.348 | 2.348 | 93.92 |
| Total Parts | 100.000 | 100.000 | 4000 |

| | Level (g/100 g FP) | |
|---|---|---|
| | Composition | |
| Ingredient | 13 | ppm* |
| disodium 4,4′-bis[(4-anilino-6-morpholino-1,3,5-triazin- | 0.113 | 4.52 |
| 2-yl)amino]stilbene-2,2′-disulphonate | | |
| Disodium 4,4′-Bis-(2-Sulfostyryl)Biphenyl | 0.038 | 1.52 |
| Carboxymethyl Cellulose | 0.114 | 4.56 |
| Lipase | 0.0014 | 0.056 |
| DTPA Agglomerate | 0.281 | 11.24 |
| Sokalan CP 5 (polymer supplied by BASF) | 0.777 | 31.08 |
| Phosphodiesterase | 0.002 | 0.08 |
| LAS | 14.785 | 591.4 |
| Hueing Dye | 0.038 | 1.52 |
| Mannanase | 0.0001 | 0.004 |
| Sodium Carbonate | 21.140 | 845.6 |
| Sodium Sulphate | 46.379 | 1855.16 |
| Amylase | 0.0006 | 0.024 |
| Sodium Percarbonate | 3.000 | 120 |
| Protease | 0.008 | 0.32 |
| C12-14-alkyl sulfate sodium salt | 4.538 | 181.52 |
| Silicate - 2.35R | 1.339 | 53.56 |
| Tetraacetylethylenediamine | 0.400 | 16 |
| Zeolite A | 2.678 | 107.12 |
| 2,4,8,10-Tetraoxaspiro[5.5]undecane-3,9-diylbis(2- | 0.253 | 10.12 |
| methylpropane-2,1-diyl) bis(3-(3-(tert-butyl)-4- | | |
| hydroxy-5-methylphenyl)propanoate) | | |
| Water | 1.767 | 70.68 |
| Perfume, processing aids and aesthetics | 2.348 | 93.92 |
| Total Parts | 100.000 | 4000 |

*ppm where present.

### II. Test Procedure

| Test Equipment | Tumbling tubes |
|---|---|
| Wash Volume | 500 ml |
| Water Hardness | Deionised water spiked to 0.0012 ppm Fe³⁺ |
| | and/or 19.2 gpg hardness (Ca²⁺ and Mg²⁺) |
| Water Temperature | 40° C. |
| Detergent addition | 2 g |

### Tumbling Tube Testing of Antioxidants at Equimolar and Equal Active Level

Determination of antioxidant impact on detergent flash suds using tumbling tubes method was completed using the following procedure. Four external replicates were completed for each test product. The Flash Suds Testing Protocol employs a suds tube machine (tumbling tubes) with 8 transparent acrylic cylindrical tubes (height 30 cm; inner diameter 9 cm; outer diameter 10 cm) removably set in a rigid metal frame connected with an electrical motor that rotates the tubes end-over-end about their midpoints at a fixed speed of 30 (±3) rpm. The tubes' lids are removable and watertight. The scales for reading the suds level are self-adhesive strips pre-graduated in centimetres with 0-cm levelled at the base of the tube. 4 g of each detergent composition was dissolved into 500 mL deionised water with low agitation to prevent generation of suds. Water hardness and metal ion content was adjusted to simulate hard water by addition of 1 ml of spike solution to each pot which delivers Calcium Chloride Dihydrate (96 mg/L wash solution Ca²⁺) and Magnesium Chloride Hexahydrate (21.5 mg/L wash solution Mg²⁺) and Iron Chloride Hexahydrate (0.0012 mg/L wash solution Fe³⁺). The solutions were decanted into the 8 tubes which were sealed and inserted into the metal frame. The solutions were rotated through 50 revolutions in total. The height of liquid and suds in each tube was measured after 30 second rest period. Suds height is recorded in cm at the highest point at which the full diameter of the vessel is covered.

The testing protocol was repeated for addition of 1 ml of spike solution which delivered Calcium Chloride Dihydrate (96 mg/L wash solution Ca²⁺) and Magnesium Chloride Hexahydrate (21.5 mg/L wash solution Mg²⁺) to adjust water hardness for comparative examples (in the absence of iron chloride hexahydrate).

### Results

Tables below display delta suds height versus Composition 1 (nil antioxidant) in cm for addition of antioxidant.

### Example I

Inventive Example—Testing of antioxidants at equimolar level to methyl 3-(3,5-di-tert-butyl-4-hydroxyphenyl) propanoate with heavy metal addition.

| | Composi- | Composi- | Composi- | Composi- | Composi- | Composi- |
|---|---|---|---|---|---|---|
| | tion 2 | tion 3 | tion 4 | tion 5 | tion 6 | tion 7 |
| Delta vs. Composition 1 | 1.025 | 0.950 | 1.225 | 1.425 | 1.375 | 1.100 |
| (50 revolutions) | | | | | | |
| St Dev (50 revolutions) | 0.222 | 0.392 | 0.287 | 0.330 | 0.150 | 0.733 |

Comparative Example—Testing of antioxidants at equimolar level to methyl 3-(3,5-di-tert-butyl-4-hydroxyphenyl) propanoate without heavy metal addition.

| | Composi- | Composi- | Composi- | Composi- | Composi- | Composi- |
|---|---|---|---|---|---|---|
| | tion 2 | tion 3 | tion 4 | tion 5 | tion 6 | tion 7 |
| Delta vs. Composition 1 | 0.000 | −0.250 | −0.300 | −0.500 | −0.400 | −0.925 |
| (50 revolutions) | | | | | | |
| St Dev (50 revolutions) | 0.096 | 0.150 | 0.556 | 0.685 | 0.680 | 0.841 |

Addition of antioxidant shows significant increase in suds height measured in compositions 2-7 in presence of Fe³⁺ ions. Without Fe³⁺ ions present no increase in suds height results.

### Example II

Inventive Example—Testing of antioxidants at 0.1 wt % with heavy metal addition.

| | Com- | Com- | Com- | Com- |
|---|---|---|---|---|
| | position | position | position | position |
| | 2 | 8 | 9 | 10 |
| Delta vs. Composition 1 | 1.125 | 1.200 | 0.900 | 1.175 |
| (50 revolutions) | | | | |
| St Dev (50 revolutions) | 0.287 | 0.572 | 0.141 | 0.330 |

Comparative Example—Testing of antioxidants at 0.1 wt % without heavy metal addition.

| | Com- | Com- | Com- | Com- |
|---|---|---|---|---|
| | position | position | position | position |
| | 2 | 8 | 9 | 10 |
| Delta vs. Composition 1 | 0.225 | 0.550 | 0.175 | 0.675 |
| (50 revolutions) | | | | |
| St Dev (50 revolutions) | 0.250 | 0.163 | 0.881 | 0.695 |

Addition of antioxidant shows significant increase in suds height measured in compositions 2,8,9 and 10 in presence of Fe³⁺ ions. The increase in suds height is greater when Fe³⁺ is added to solution versus when no Fe³⁺ is added to solution.

### Example III

Inventive Example—Testing of antioxidants at equimolar level to methyl 3-(3,5-di-tert-butyl-4-hydroxyphenyl) propanoate with heavy metal addition.

| | Composition 3 | Composition 11 | Composition 12 |
|---|---|---|---|
| Delta vs. | 1.025 | 0.400 | 1.000 |
| Composition 1 | | | |
| (50 revolutions) | | | |
| St Dev | 0.287 | 0.183 | 0.216 |
| (50 revolutions) | | | |

Comparative Example—Testing of antioxidants at equimolar level to methyl 3-(3,5-di-tert-butyl-4-hydroxyphenyl) propanoate without heavy metal addition

| | Composition 3 | Composition 11 | Composition 12 |
|---|---|---|---|
| Delta vs. | 0.450 | −0.100 | −0.025 |
| Composition 1 | | | |
| (50 revolutions) | | | |
| St Dev | 0.436 | 0.245 | 0.287 |
| (50 revolutions) | | | |

Addition of antioxidant shows significant increase in suds height measured in compositions 3, 11 and 12 in presence of Fe³⁺ ions. The increase in suds height is greater when Fe³⁺ is added to solution versus when no Fe³⁺ is added to solution.

### Example IV

Inventive Example—Testing of antioxidant at equimolar level to methyl 3-(3,5-di-tert-butyl-4-hydroxyphenyl) propanoate with heavy metal addition.

| | Composition 13 |
|---|---|
| Delta vs. Composition 1 | 1.150 |
| (50 revolutions) | |
| St Dev (50 revolutions) | 0.236 |

Comparative Example—Testing of antioxidant at equimolar level to methyl 3-(3,5-di-tert-butyl-4-hydroxyphenyl) propanoate without heavy metal addition.

| | Composition 13 |
|---|---|
| Delta vs. Composition 1 | 0.125 |
| (50 revolutions) | |
| St Dev (50 revolutions) | 0.263 |

Addition of antioxidant shows significant increase in suds height measured in composition 13 in presence of Fe³⁺ ions. Without Fe³⁺ ions present no significant difference in suds height is visible.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising the steps of:
(a) contacting a detergent composition comprising linear alkylbenzene sulphonate detersive surfactant, C₈-C₂₄ alkyl sulphate detersive surfactant and phenolic antioxidant having the structure: 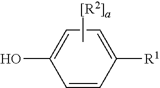
wherein the index a is about 1 or about 2,
wherein when a is about 1, R² is t-butyl and R¹ is —OCH₃,
wherein when a is about 2, one R² is t-butyl and the other R² is selected from t-butyl and methyl,
wherein, when a is about 2 at least one R² group must be ortho to the hydroxyl group,
wherein R¹ is selected from the group consisting of methyl, t-butyl, and (C_{b}H_{2b})C(O)R³, where the index b is about 2 or about 3,
wherein R³ is selected from the group consisting of:
(i) OR⁴ where R⁴ is selected from C₁-C₁₈ linear or branched alkyl; —O—Q—O—G, where Q is selected from the group consisting of:
C₂-C₈ linear or branched alkylene; 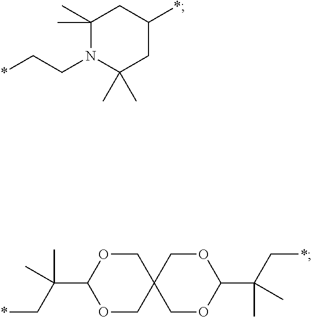
and any combination thereof; 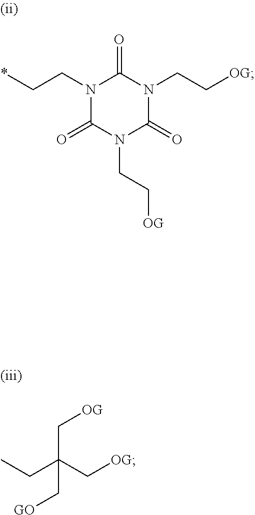
and
(iv) any combination thereof;
wherein each G is independently selected from the group consisting of H and 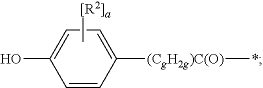
wherein f is about 1 or about 2,
wherein when f is 1, R⁵ is t-butyl,
wherein when f is about 2, one R⁵ is t-butyl and the other R⁵ is selected from t-butyl and methyl,
wherein when f is about 2, at least one R⁵ group must be ortho to the hydroxyl group,
wherein g is about 2 or about 3,
wherein f, g, and R⁵ are independently selected for each G group,
with water to form a wash liquor comprising from about 50 ppm to about 2000 ppm linear alkylbenzene sulphonate detersive surfactant and from about 10 to about 750 ppm C₈-C₂₄ alkyl sulphate, from about 0.1 ppm to about 200 ppm phenolic antioxidant and from about 0.001 ppm to about 10.0 ppm iron, and having a pH in the range of from greater than about 7.0 to about 12.0, and wherein the molar ratio of linear alkylbenzene sulphonate detersive surfactant to C₈-C₂₄ alkyl sulphate detersive surfactant present in the wash liquor is in the range of from about 0.05 to about 200;
(b) contacting fabric with the wash liquor; and
(c) laundering the fabric.

2. A method according to claim 1, wherein the phenolic antioxidant has a structure selected from:

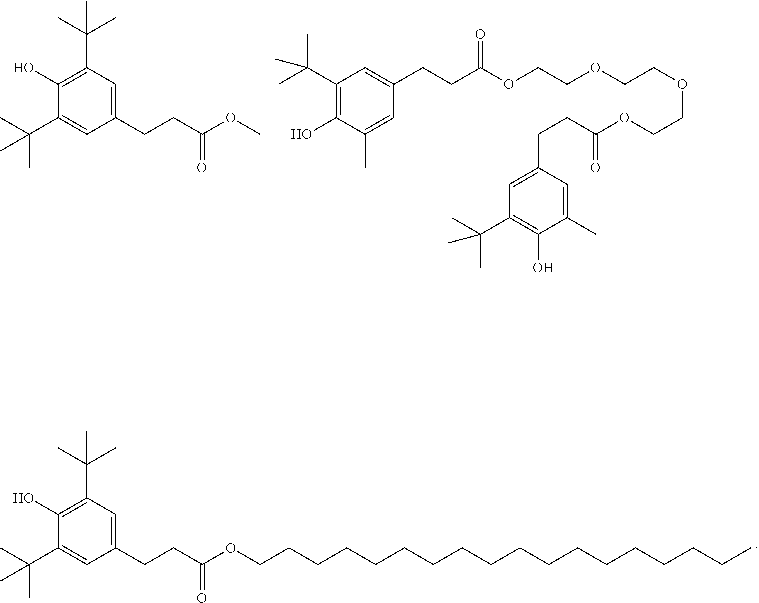 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

3. A method according to claim 1, wherein the phenolic antioxidant is octadecyl di-t-butyl-4-hydroxyhydrocinnamate.

4. A method according to claim 1, wherein the C₈-C₂₄ alkyl sulphate detersive surfactant is a C₁₂-C₁₄ alkyl sulphate detersive surfactant.

5. A method according to claim 1, wherein the linear alkylbenzene sulphonate detersive surfactant is a C₁₁-C₁₃ linear alkylbenzene sulphonate.

6. A method according to claim 1, wherein the molar ratio of linear alkylbenzene sulphonate detersive surfactant and C₈-C₂₄ alkyl sulphate detersive surfactant present in the wash liquor is in the range of from about 0.1 to about 50.

7. A method according to claim 1, wherein the wash liquor comprises from about 0.4 ppm to about 5.0 ppm iron.

8. A method according to claim 1, wherein the wash liquor has a pH of from about 10.0 to about 12.0.

9. A method according to claim 1, wherein the wash liquor has a pH of from above about 7.0 to less than about 10.0.

10. A method according to claim 1, wherein the detergent composition comprises chelant, and wherein the wash liquor comprises from about 0.4 ppm to about 200 ppm chelant.

11. A method according to claim 1, wherein the chelant is selected from DETA, MGDA, EDDS, TETA, and any combination thereof.

12. A method according to claim 1, wherein the detergent composition comprises perfume, and wherein the wash liquor comprises from about 0.2 ppm to about 200 ppm perfume.

13. A method according to claim 1, wherein the detergent composition comprises protease, and wherein the wash liquor comprises from about 0.2 ppm to about 80 ppm protease.

14. A method according to claim 1, wherein the detergent composition comprises hueing agent, and wherein the wash liquor comprises from about 0.01 ppm to about 200 ppm hueing agent.
